(19) United States
(12) Patent Application Publication
(10) Pub. No.: US 2018/0017453 A1
(43) Pub. Date: Jan. 18, 2018

(54) TORQUE DETECTOR

(71) Applicants: CHIA-SHENG LIANG, TAIPEI CITY (TW); SAFEWAY ELECTRO-MECHANICAL CO., LTD., NEW TAIPEI CITY (TW)

(72) Inventor: CHIA-SHENG LIANG, TAIPEI CITY (TW)

(21) Appl. No.: 15/258,106

(22) Filed: Sep. 7, 2016

(30) Foreign Application Priority Data
Jul. 18, 2016 (TW) 105122617

(51) Int. Cl. G01L 3/10

(52) U.S. Cl. CPC G01L 3/102

(57) ABSTRACT

A torque detector on an axle is provided with a torque transferring sleeve rotatably disposed on the axle and including a power input at one end, a power output at the other end, first and second spiral ribs on an intermediate portion of an outer surface, the second spiral ribs extending in a spiral direction opposite to that of the first spiral ribs; a first electromagnetic coil core formed of a material having magnetic permeability, surrounded by the first spiral ribs, and secured to the axle; a second electromagnetic coil core formed of a material having magnetic permeability, surrounded by the second spiral ribs, and secured to the axle; and a winding wound about the first and second electromagnetic coil cores. In response to a torque exerted on the torque transferring sleeve, the winding detects a magnetic permeability change of each of the first and second spiral ribs.

### BACKGROUND OF THE INVENTION

### 1. Technical Field

The invention relates to torque detectors and more particularly to a magnetostrictive torque detector having a torque transferring sleeve.

### 2. Related Art

Methods for detecting torque of a rotating shaft (or a stationary shaft) by using a device made of a material having a magnetostrictive characteristic are well known in the art. The device exerts a twisting force at an end of the rotating shaft (or the stationary shaft) to detect magnetic permeability change of the rotating shaft (or the stationary shaft). And in turn, the magnetic permeability change can be used to calculate the twisting force exerted on the rotating shaft (or the stationary shaft). The magnetostrictive torque detection is a non-contact type of torque detection. In comparison with other conventional torque detection methods, it has the advantages of no wear loss, minimum maintenance, and high reliability.

Regarding magnetostrictive, it is a phenomenon that magnetic permeability of a member changes in response to an expansional or compressional force exerted thereon. It is defined that a member has a positive magnetostrictive characteristic if its magnetic permeability increases in proportion to the expansional force increase or decreases in proportion to the compressional force increase. To the contrary, it is defined that a member has a negative magnetostrictive characteristic if its magnetic permeability decreases in proportion to the expansional force decrease or increases in proportion to the compressional force decrease. For example, in response to a twisting force (i.e., torque) exerted on an end of a shaft, an expansional force is generated at a position at an angle of 45 degrees with respect to the longitudinal axis of the shaft, and a compressional force is generated at a position at an angle of −45 degrees with respect to the longitudinal axis of the shaft. And in turn, the magnetic permeability of the shaft changes i.e., increases or decreases. A first winding as a first torque detector is provided at a position at an angle of 45 degrees with respect to the longitudinal axis of the shaft, and a second winding as a second torque detector is provided at a position at an angle of −45 degrees with respect to the longitudinal axis of the shaft by taking above phenomenon into consideration. Alternatively, first spiral ribs (or grooves) are provided on one end of the shaft and second spiral ribs (or grooves) are provided on the other end of the shaft in which the first spiral ribs (or grooves) extend in a direction perpendicular to that of the second spiral ribs (or grooves). Further, a winding as a torque detector is provided on the shaft covering the first and second spiral ribs (or grooves). Inductance of the winding changes when the magnetic permeability of the shaft changes. Torque of the shaft can be detected when alternating current (AC) is supplied to the winding. Above technologies can be found in many patents including US Pat. Nos. 4,506,554, 4,697,459, 4,765,192 and 4,823,620.

A conventional magnetostrictive torque detector includes a central axle, a winding wound thereon as detection means, and a cylindrical electromagnetic coil core surrounding the winding for increasing detection precision. Above torque detector is also provided on an electrically assisted bicycle and can be found in US Pat. No. 8,807,260 and Taiwan Utility Model No. 293,508. Typically, the torque detector is mounted in a bottom bracket of an electric bicycle for detecting torque generated on a crank arm when pedaling. The torque is converted into a digital signal which is in turn sent to a control unit for further processing so as to control an electric motor of the electric bicycle. However, modification of the bicycle frame is required, assembly of the bicycle is more time consuming and complex, and it limits applications.

Notwithstanding the prior art, the invention is neither taught nor rendered obvious thereby.

### BRIEF SUMMARY

It is desirable to provide an improved torque detector for a bicycle for detecting force exerted on pedals by a rider when pedaling. Power input of the bicycle is from the pedals being pushed, power output thereof is a rear wheel, and the torque detector is provided between the pedals and the rear wheel. Alternatively, the torque detector is provided for detecting the pedaling force only. Specifically, the invention provides a torque detector in the hub of the rear wheel without modifying the bicycle frame, the crank arms, the bottom bracket and the sprocket wheels. Further, its assembly is simplified.

It is therefore an object of the invention to provide a torque detector disposed on an axle, comprising a hollow torque transferring sleeve formed of metal, rotatably disposed on the axle, and including a power input at a first end, a power output at a second end, a plurality of first spiral ribs disposed on an intermediate portion of an outer surface, and a plurality of second spiral ribs disposed on the intermediate portion of the outer surface, the second spiral ribs extending in a spiral direction opposite to that of the first spiral ribs; a first electromagnetic coil core formed of a material having magnetic permeability, surrounded by the first spiral ribs, and secured to the axle; a second electromagnetic coil core formed of a material having magnetic permeability, surrounded by the second spiral ribs, and secured to the axle; and a winding wound about the first and second electromagnetic coil cores; wherein in response to a torque exerted on the torque transferring sleeve, the winding is configured to detect a magnetic permeability change of each of the first and second spiral ribs.

Preferably, each of the first spiral ribs and the second spiral ribs includes a plurality of parallel, equally spaced ribs.

Preferably, the first and second spiral ribs are at an angle of θ with respect to a longitudinal axis of the axle and 0°<|θ|≦45°.

Preferably, each of the first and second electromagnetic coil cores includes a hollow cylindrical portion, an annual first flange at a first end of the hollow cylindrical portion, and an annular second flange at a second end of the hollow cylindrical portion.

Preferably, further comprises a gap formed between the torque transferring sleeve and each of the first and second flanges.

Preferably, further comprises a first magnetic loop including the first spiral ribs, the first electromagnetic coil core, and the gap; and a second magnetic loop including the second spiral ribs, the second electromagnetic coil core, and the gap.

Preferably, winding includes first and second excitation coils, and first and second measurement coils put on the first and second electromagnetic coil cores respectively.

Preferably, the first excitation coils are in series with the second excitation coils and both wind in the same spiral direction, and the first measurement coils are in series with the second measurement coils, the first measurement coils winding in a spiral direction opposite to that of the second measurement coils.

Preferably, the first measurement coils are in series with the second measurement coils and both wind in the same spiral direction, and the first excitation coils are in series with the second excitation coils, the first excitation coils winding in a spiral direction opposite to that of the second excitation coils.

Preferably, the power input of the torque transferring sleeve is attached to a flywheel of a bicycle, and the power output thereof is attached to a hub motor.

Preferably, further comprises an EMI suppression device comprising a first EMI suppression sleeve disposed between the axle and both the first and second electromagnetic coil cores wherein the first EMI suppression sleeve, the first electromagnetic coil core, the second electromagnetic coil core, and the axle are secured together; a second EMI suppression sleeve put on the torque transferring sleeve; and three spaced apart EMI suppression rings secured to ends of the first and second electromagnetic coil cores, thereby preventing external EMI from entering and electromagnetic waves generated by the first and second excitation coils from leaving.

By utilizing the invention, the following advantages are obtained: The torque transferring sleeve having magnetostrictive characteristic is provided as an outer layer. First spiral ribs and second spiral ribs are formed on the torque transferring sleeve for transmission purposes. In response to supplying AC to the excitation coils, a magnetic field is generated and passes through the spiral ribs. This is different from the conventional solid axle. The generated magnetic field mainly passes through the longitudinal axis of the axle rather than spiral ribs on the surface thereof. Therefore, the magnetostrictive characteristic of the torque transferring sleeve can be fully shown.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an exploded view of a torque detector according to the invention, a hub motor, a flywheel and other associated components;

FIG. 2 is longitudinal sectional view of the assembled torque detector and other components shown in FIG. 1;

FIG. 3 is an enlarged view of the torque detector shown in FIG. 2;

FIG. 4 is a sectional view taken along line A-A of FIG. 3;

FIG. 5 is an enlarged view of the central portion of FIG. 3;

FIG. 6 is a circuit diagram of the winding;

FIG. 7 is a schematic side view of the ratchet of the hub motor viewed from the left side of a bicycle showing a counterclockwise rotation; and

FIG. 8 is a view similar to FIG. 7 showing a clockwise rotation.

### DETAILED DESCRIPTION

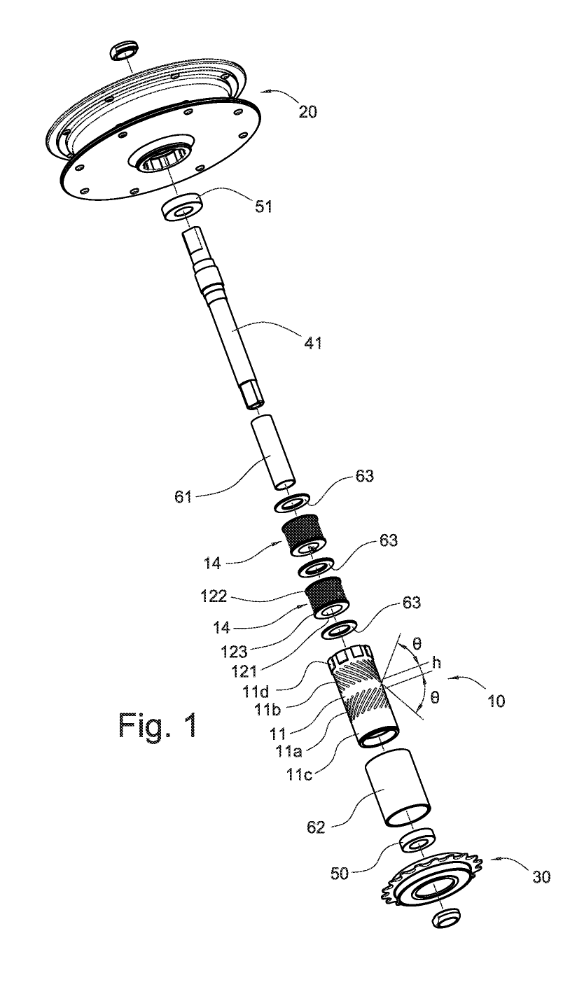

Referring to FIGS. 1 to 8, a torque detector 10 in accordance with the invention is mounted on an axle 41 through a hub motor 20 which is in turn mounted in a hub of a rear wheel of a bicycle. The torque detector 10 comprises a torque transferring sleeve 11, a first electromagnetic coil core 12a, a second electromagnetic coil core 12b, and a winding 14. The torque transferring sleeve 11 is made of metal having alloyants of chromium and molybdenum or having alloyants of nickel, chromium and molybdenum so as to be magnetostrictive. The torque transferring sleeve 11 is hollow. An intermediate portion of an outer surface of the torque transferring sleeve 11 is provided with first spiral ribs 11a and second spiral ribs 11b which extend in a spiral direction opposite to that of the first spiral ribs 11a. The first spiral ribs 11a and the second spiral ribs 11b are spaced apart by a distance h (see FIG. 1). Each of the first spiral ribs 11a and the second spiral ribs 15b11b has a plurality of parallel, equally spaced ribs. The first electromagnetic coil core 12a is surrounded by the first spiral ribs 11a and the second electromagnetic coil core 12b is surrounded by the second spiral ribs 11b respectively. The first electromagnetic coil core 12a and the second electromagnetic coil core 12b are put on a first electromagnetic interference (EMI) suppression sleeve 61 which is in turn put on the axle 41. The winding 14 includes two sets of inner and outer coils 15 and 16 in which the inner coils 15 are put on the first electromagnetic coil core 12a (or the second electromagnetic coil core 12b) and the outer coils 16 are put on the winding 14. The inner and outer coils 15 and 16 are used to detect magnetic permeability change of the torque transferring sleeve 11 in response to torque at each of the first spiral ribs 11a and the second spiral ribs 11b.

In the invention, each rib of the first spiral ribs 11a (or the second spiral ribs 11b) is at an angle of θ with respect to the longitudinal axis of the axle 41 and 0°<|θ|≦45° (see FIG. 1). In response to torque on the torque transferring sleeve 11, either (i) compressional force is exerted on the first spiral ribs 11a and expansional force is exerted on the second spiral ribs 11b, or (ii) expansional force is exerted on the first spiral ribs 11a and compressional force is exerted on the second spiral ribs 11b. In the case of compressional force exerted on the first spiral ribs 11a and expansional force exerted on the second spiral ribs 11b, and the torque transferring sleeve 11 is made of a positive magnetostrictive material, magnetic permeability of the first spiral ribs 11a decreases and that of the second spiral ribs 11b increases. A first bearing 50 is provided between the axle 41 and a flywheel 30 and a second bearing 51 is provided between the axle 41 and one side of the hub motor 20 so that the torque transferring sleeve 11 may smoothly rotate about the axle 41.

The first and second electromagnetic coil cores 12a and 12b are made of a material having a high magnetic permeability such as martensitic stainless steel, pure iron, nickel steel, or silicon steel. The first electromagnetic coil core 12a corresponds to the first spiral ribs 11a and the second electromagnetic coil core 12b corresponds to the second spiral ribs 11b respectively. The first electromagnetic coil core 12a (or the second electromagnetic coil core 12b) includes a hollow cylindrical portion 121, an annual first flange 122 at one end of the hollow cylindrical portion 121, and an annular second flange 123 at the other end of the hollow cylindrical portion 121. A gap 13 is formed between the torque transferring sleeve 11 and the first flange 122 (or the second flange 123). Specifically, a first gap 13a is formed between the torque transferring sleeve 11 and the first flange 122, and a second gap 13b is formed between the torque transferring sleeve 11 and the second flange 123. The provision of the first and second gaps 13a and 13b can prevent the torque transferring sleeve 11 from directly contacting the first and second flanges 122 and 123 in rotation so as to decrease friction.

It is noted that a first magnetic loop 17a consists of the first spiral ribs 11a and the first electromagnetic coil core 12a and a second magnetic loop 17b consists of the second spiral ribs 11b and the second electromagnetic coil core 12b. Specifically, the first magnetic loop 17aconsists of the hollow cylindrical portion 121, the first flange 122, the first gap 13a, the first spiral ribs 11a, the second gap 13b, and the second flange 123; and the second magnetic loop 17b consists of the hollow cylindrical portion 121, the first flange 122, the first gap 13a, the second spiral ribs 11b, the second gap 13b, and the second flange 123.

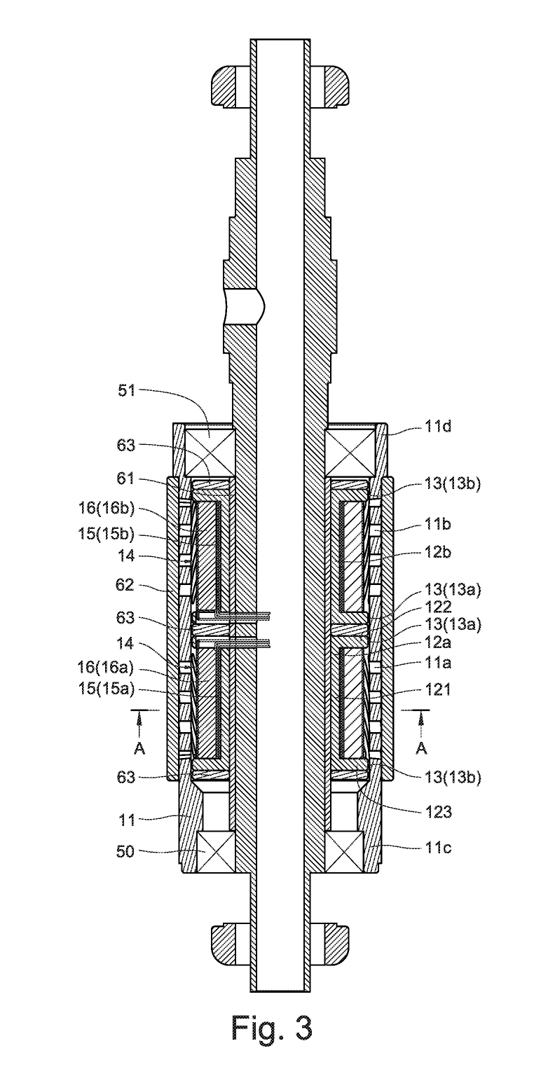

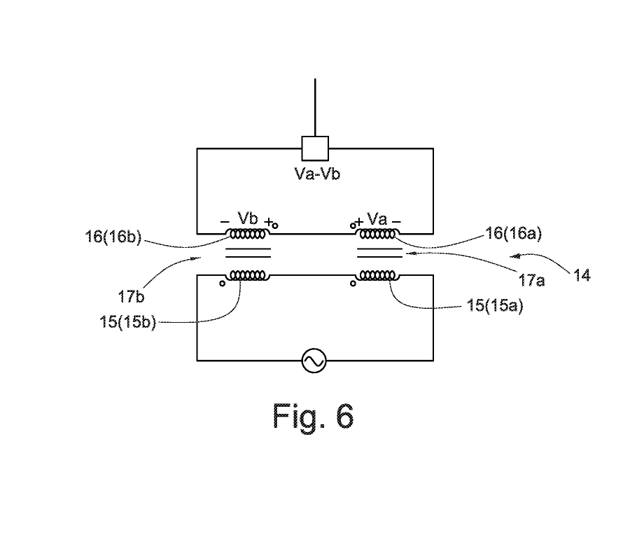

As shown in FIGS. 3 and 6, the winding 14 includes two sets of inner and outer coils 15 and 16. Specifically, the winding 14 includes first and second excitation coils 15a and 15b, and first and second measurement coils 16a and 16b put on the first and second electromagnetic coil cores 12a and 12b. More specifically, the first excitation coils 15a are put on the first electromagnetic coil core 12a, and the second excitation coils 15b is put on the second electromagnetic coil core 12b; and the first measurement coils 16a are put on the first electromagnetic coil core 12a, and the second measurement coils 16b is put on the second electromagnetic coil core 12b. The first and second excitation coils 15a and 15b are inner coils of the first and second electromagnetic coil cores 12a and 12b, and the first and second measurement coils 16a and 16b are outer coils of the first and second electromagnetic coil cores 12a and 12b. The number of the winding of the first excitation coils 15a are N and the number of the winding of the second excitation coils 15b is also N. The number of the winding of the first measurement coils 16a are M and the number of the winding of the second measurement coils 16b is also M which is a multiple of N.

Winding arrangement of the invention is shown in FIG. 6. The first excitation coils 15a are in series with the second excitation coils 15b and both wind in the same spiral direction. The first measurement coils 16a are in series with the second measurement coils 16b in which the first measurement coils 16a wind in a spiral direction opposite to the spiral direction of the second measurement coils 16b. Alternatively, the first excitation coils 15a are in series with the second excitation coils 15b in which the first excitation coils 15a wind in a spiral direction opposite to the spiral direction of the second excitation coils 15b. The first measurement coils 16a are in series with the second measurement coils 16b and both wind in the same spiral direction. Magnetic field is generated in the first magnetic loop 17a when AC is supplied to the first excitation coils 15a and magnetic field is generated in the second magnetic loop 17b when AC is supplied to the second excitation coils 15b. Strength and direction of the magnetic field are changed in response to the sinusoidal curve of the AC. According to Faraday's law, AC voltages Va and Vb are generated by the first and second measurement coils 16a and 16b due to induction. Voltages Va and Vb are expressed below.

Va=Am×cos(ωt)

Vb=Bm×cos(ωt)

where Am is peak voltage induced by the first measurement coils 16a, and Bm is peak voltage induced by the second measurement coils 16b. Sum of voltage induced by the first measurement coils 16a and voltage induced by the second measurement coils 16b is zero because winding directions of the series connected first and second measurement coils 16a and 16b are in opposite spiral direction. Voltage Vab across two ends of the series connected first and second measurement coils 16a and 16b is expressed below.

Vab=Va−Vb=(Am−Bm)×cos(ωt)

Magnetic resistance of the first magnetic loop 17a is equal to that of the second magnetic loop 17b when the torque transferring sleeve 11 does not have torque. Thus, inductance of the first excitation coils 15a are equal to that of the second excitation coils 15b, and impedance of the first excitation coils 15a are equal to that of the second excitation coils 15b. Thus, voltage across the first excitation coils 15a is equal to voltage across the second excitation coils 15b. Induced voltage Va of the first measurement coils 16a is equal to induced voltage Vb of the second measurement coils 16b, i.e., Am=Bm and Vab=0. In response to torque on the torque transferring sleeve 11, compressional force is exerted on the first spiral ribs 11a, expansional force is exerted on the second spiral ribs 11b, and the torque transferring sleeve 11 is made of a positive magnetostrictive material, magnetic permeability of the first spiral ribs 11a decreases and magnetic permeability of the second spiral ribs 11b increases. Thus, magnetic resistance of the first magnetic loop 17a is greater than that of the second magnetic loop 17b, inductance of the first excitation coils 15a are less than that of the second excitation coils 15b, impedance of the first excitation coils 15a are less than that of the second excitation coils 15b, voltage across the first excitation coils 15a are less than that across the second excitation coils 15b, absolute value of induced voltage Va of the first measurement coils 16a are less than absolute value of induced voltage Vb of the second measurement coils 16b, i.e., Am<Bm, and Vab=Va−Vb=(Am−Bm)×cos(ωt)≠0.

As described above, Vab is caused by a difference between inductance of the first excitation coils 15a and that of the second excitation coils 15b. The inductance difference is caused by magnetic permeability changes of the first spiral ribs 11a and the second spiral ribs 11b, i.e., torque change of the torque transferring sleeve 11. Therefore, the winding 14 can be used to detect torque on the torque transferring sleeve 11.

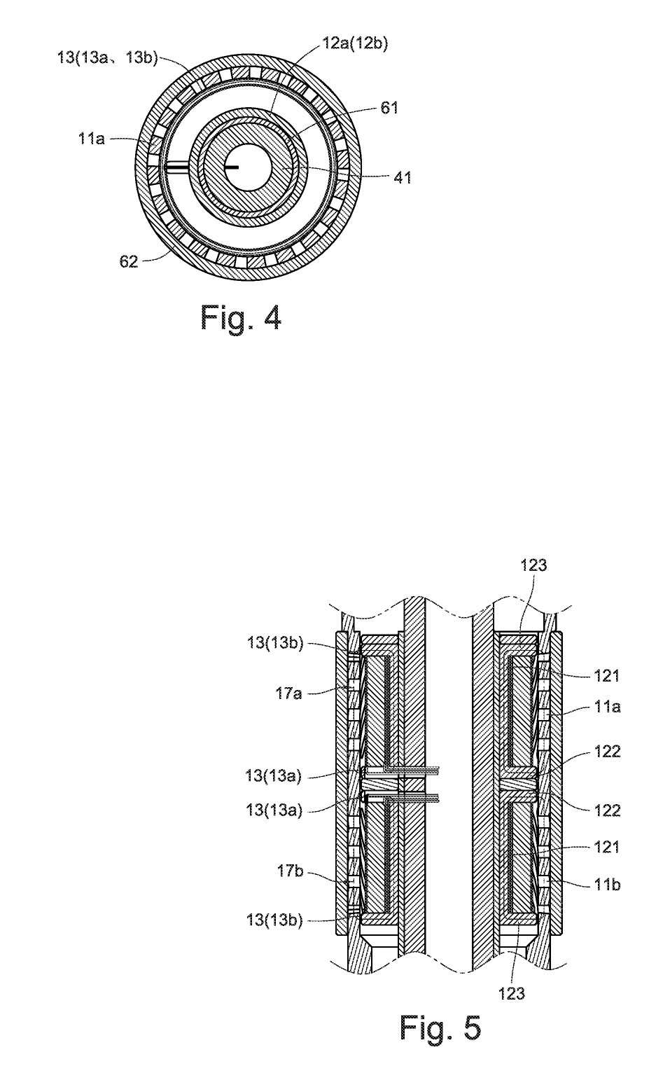

As shown in FIGS. 1 and 3, an EMI suppression device having high conductance and low magnetic permeability includes a first EMI suppression sleeve 61, a second EMI suppression sleeve 62, and three EMI suppression rings 63. The first EMI suppression sleeve 61 is mounted between the axle 41 and both the first and second electromagnetic coil cores 12a and 12b (see FIG. 4). The first EMI suppression sleeve 61, the first electromagnetic coil core 12a, the second electromagnetic coil core 12b, and the axle 41 are secured together. The second EMI suppression sleeve 62 is put on the torque transferring sleeve 11. The EMI suppression rings 63 are spaced apart and secured to ends of the first and second electromagnetic coil cores 12a and 12b. As a result, EMI from external sources are prevented from entering and electromagnetic waves generated by the first and second excitation coils 15a and 15b are prevented from leaving. It is emphasized that the first electromagnetic coil core 12a, the second electromagnetic coil core 12b, the winding 14, the EMI suppression rings 63, the first EMI suppression sleeve 61 and the axle 41 are secured together; the second EMI suppression sleeve 62 is put on the torque transferring sleeve 11; and the first and second bearings 50 and 51 are provided to rotatably support the torque transferring sleeve 11 on the axle 41. Further, the gap 13 formed between the torque transferring sleeve 11 and the first flange 122 (or the second flange 123) can decrease friction in rotation.

The torque transferring sleeve 11 further comprises a power input end 11c and a power output end 11d. The power input end 11c is attached to a flywheel 30 and the power output end 11d is attached to a hub motor 20. Therefore, the torque detector 10 and the hub motor 20 can be mounted on the hub of a rear wheel of a bicycle.

A ratchet (not shown) is mounted on the flywheel 30 of a bicycle. As viewed from the left side of the bicycle showing a counterclockwise rotation of the flywheel 30, a torque is exerted on the torque transferring sleeve 11 by the flywheel 30. To the contrary, as viewed from the left side of the bicycle showing a clockwise rotation of the flywheel 30, no torque is exerted on the torque transferring sleeve 11 by the flywheel 30.

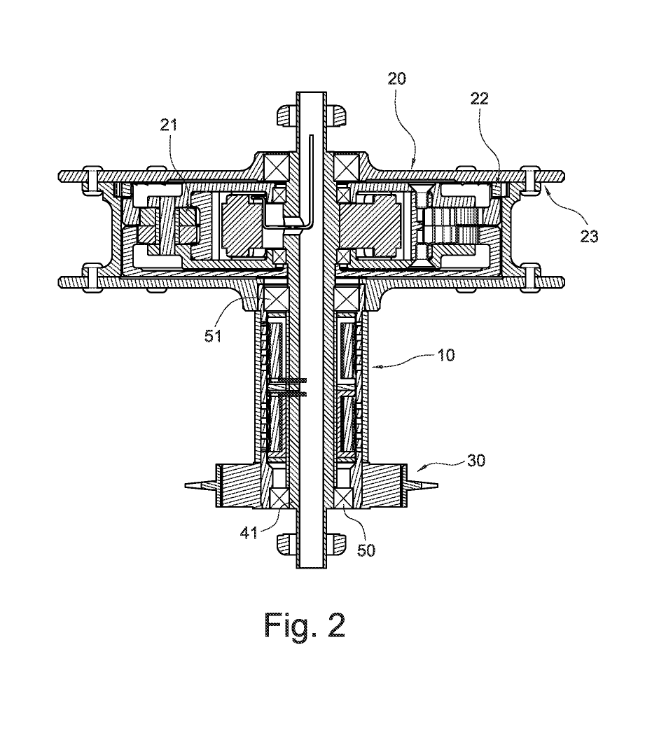

Components of the hub motor 20 are described below. As shown in FIG. 2, the hub motor 20 comprises a reduction gear 21, a ratchet 22 and a hub 23. Operation of the reduction gear 21 is omitted herein for the sake of brevity.

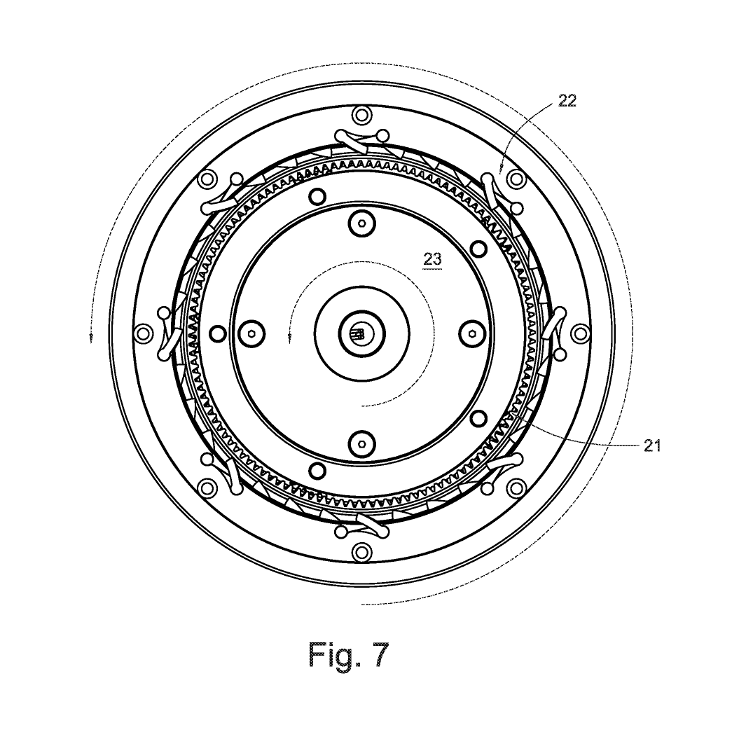

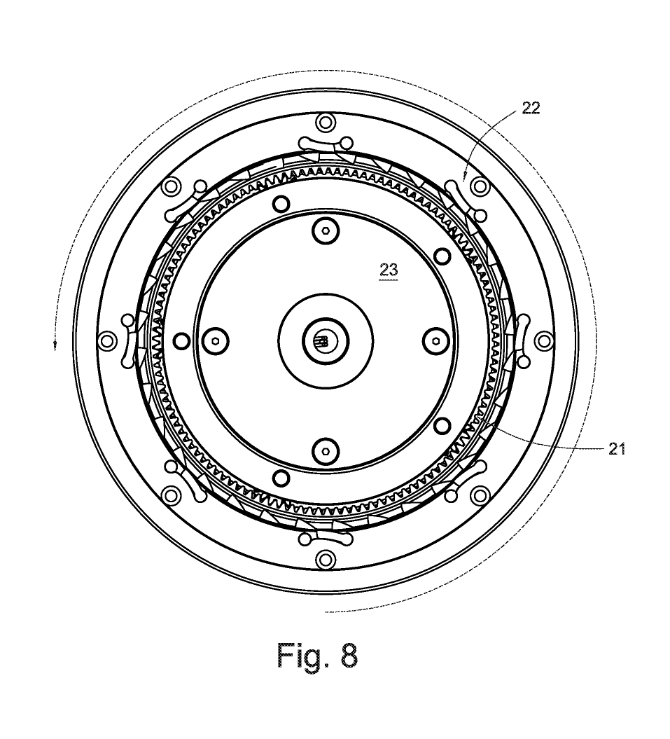

FIGS. 7 and 8 each shows a view from the left side of the bicycle, i.e., from the top of FIG. 2. In FIG. 7, the bicycle moves forward when the hub 23 rotates counterclockwise. Also, the reduction gear 21 as driven by the rotating hub motor 20 rotates counterclockwise. And in turn, the ratchet 22 engages the hub 23 to rotate the hub 23 counterclockwise.

In FIG. 8, the reduction gear 21 stops rotation because the hub motor 20 is deactivated. The hub 23 as driven by another means rotates counterclockwise and the ratchet 22 disengages from the hub 23.

A rider may pedal a bicycle to exert a twisting force on the flywheel 30 via chain (not shown). The force is transmitted to the hub 23 to move the bicycle forward in which the flywheel 30 also transmits the force to the power input end 11c of the torque transferring sleeve 11 and the power output end 11d thereof outputs the force (i.e., torque) to move the bicycle forward and even in acceleration. The torques exerted on all cross-sections perpendicular to the longitudinal axis of the torque transferring sleeve 11 are the same. Compressional force and expansional force are presented when the cross-sections are at 45-degree with respect to the longitudinal axis of the torque transferring sleeve 11. Specifically, compressional force is exerted on the first spiral ribs 11a to decrease magnetic permeability, and expansional force is exerted on the second spiral ribs 11b to increase magnetic permeability. Also, AC is supplied to both the first and second excitation coils 15a and 15b to generate magnetic fields in the first and second magnetic loops 17a and 17b respectively. As discussed above, voltage Vab across two ends of the series connected first and second measurement coils 16a and 16b is expressed below.

Vab=Va−Vb=(Am−Bm)×cos(ωt)

Am−Bm is proportional to the torque. The Vab is applied to a signal processing device which controls output power of the hub motor in which the output power is proportional to Vab. As a result, a rider may exert less force to overcome irregularities on the road or ride on an uphill road.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A torque detector disposed on an axle, comprising:
a hollow torque transferring sleeve formed of metal, rotatably disposed on the axle, and including a power input at a first end, a power output at a second end, a plurality of first spiral ribs disposed on an intermediate portion of an outer surface, and a plurality of second spiral ribs disposed on the intermediate portion of the outer surface, the second spiral ribs extending in a spiral direction opposite to that of the first spiral ribs;
a first electromagnetic coil core formed of a material having magnetic permeability, surrounded by the first spiral ribs, and secured to the axle;
a second electromagnetic coil core formed of a material having magnetic permeability, surrounded by the second spiral ribs, and secured to the axle; and
a winding wound about the first and second electromagnetic coil cores;
wherein in response to a torque exerted on the torque transferring sleeve, the winding is configured to detect a magnetic permeability change of each of the first and second spiral ribs.

2. The torque detector of claim 1, wherein each of the first spiral ribs and the second spiral ribs includes a plurality of parallel, equally spaced ribs.

3. The torque detector of claim 1, wherein the first and second spiral ribs are at an angle of θ with respect to a longitudinal axis of the axle and 0°<|θ|≦45°.

4. The torque detector of claim 1, wherein each of the first and second electromagnetic coil cores includes a hollow cylindrical portion, an annual first flange at a first end of the hollow cylindrical portion, and an annular second flange at a second end of the hollow cylindrical portion.

5. The torque detector of claim 4, further comprising a gap formed between the torque transferring sleeve and each of the first and second flanges.

6. The torque detector of claim 5, further comprising a first magnetic loop including the first spiral ribs, the first electromagnetic coil core, and the gap; and a second magnetic loop including the second spiral ribs, the second electromagnetic coil core, and the gap.

7. The torque detector of claim 1, wherein the winding includes first and second excitation coils, and first and second measurement coils put on the first and second electromagnetic coil cores respectively.

8. The torque detector of claim 7, wherein the first excitation coils are in series with the second excitation coils and both wind in the same spiral direction, and the first measurement coils are in series with the second measurement coils, the first measurement coils winding in a spiral direction opposite to that of the second measurement coils.

9. The torque detector of claim 7, wherein the first measurement coils are in series with the second measurement coils and both wind in the same spiral direction, and the first excitation coils are in series with the second excitation coils, the first excitation coils winding in a spiral direction opposite to that of the second excitation coils.

10. The torque detector of claim 1, further comprising an electromagnetic interference (EMI) suppression device comprising:
a first EMI suppression sleeve disposed between the axle and both the first and second electromagnetic coil cores wherein the first EMI suppression sleeve, the first electromagnetic coil core, the second electromagnetic coil core, and the axle are secured together;
a second EMI suppression sleeve put on the torque transferring sleeve; and
three spaced apart EMI suppression rings secured to ends of the first and second electromagnetic coil cores.

11. The torque detector of claim 1, wherein the power input of the torque transferring sleeve is attached to a flywheel of a bicycle, and the power output thereof is attached to a hub motor.
